(19) United States
(12) Patent Application Publication
(10) Pub. No.: US 2026/0300517 A1
(43) Pub. Date: Oct. 1, 2026

(54) REVERIFYING CLIENT DEVICE IDENTITIES USING PREVIOUS DECISIONS FOR CREATING ACCOUNTS WITHIN A DIGITAL SYSTEM

(71) Applicant: Chime Financial, Inc., San Francisco, CA (US)

(72) Inventors: Raghuram Ashok, San Francisco, CA (US); Brian Lesperance, River Forest, IL (US); Ramya Kannan, Chicago, IL (US); Jim Challenger, Chicago, IL (US); Vlad Hadzhiyski, Fort Lauderdale, FL (US); Ryan Turner, Dallas, TX (US); Acacia Sacks, San Francisco, CA (US); Dita Hito, Chapel Hill, NC (US); Archchana Shankar-Lakshmi, Portland, OR (US); Rick Dsida, Highland Park, IL (US)

(21) Appl. No.: 19/096,051

(22) Filed: Mar. 31, 2025

(51) Int. Cl. G06F 21/60; G06Q 30/018

(52) U.S. Cl. CPC G06F 21/604; G06Q 30/0185

(57) ABSTRACT

The present disclosure relates to systems, non-transitory computer-readable media, and methods for reverifying the identity of a client device requesting an account within a digital system by reusing a verification previously generated for another account of the client device. For example, one or more embodiments involve generating an identity verification for a client device based on identifying information of the client device in response to a request for a first account and creating the first account based on the identifying information. Some embodiments further involve, in response to a request for a second account, determining whether the identifying information of the client device has changed within a threshold period of time. If the identifying information has not changed, the identity verification generated for the first account is used in creating the second account.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of the device reverification system creating a second account for a client device using identifying information and model decisioning used in creating a first account in accordance with one or more embodiments.

FIG. 2 illustrates the device reverification system generating an identity verification for a client device in accordance with one or more embodiments.

FIG. 3 illustrates an example flowchart of the device reverification system reusing the identity verification generated for a first account to create a second account for a client device in accordance with one or more embodiments.

FIG. 4 illustrates an example flowchart of the device reverification system determining the third-party services system associated with client devices as part of a reverification process in accordance with one or more embodiments.

FIG. 5 illustrates graphical user interfaces displayed by a client device based on reuse of a previous verification in accordance with one or more embodiments.

FIG. 6 an example system environment in which a device reverification system can operate in accordance with one or more embodiments.

FIG. 7 illustrates a flowchart of a series of acts for reusing a previously generated identity verification for a client device in creating a new account for the client device within a digital system in accordance with one or more embodiments.

FIG. 8 illustrates a block diagram of a computing device for implementing one or more embodiments of the present disclosure.

FIG. 9 illustrates an example environment for the device reverification system in accordance with one or more embodiments.

### DETAILED DESCRIPTION

This disclosure describes one or more embodiments of a device reverification system 100 that reverifies the identity of a client device to create an account within a digital system using identifying information and model decisioning used in creating another account. For example, in one or more embodiments, the device reverification system 100 generates an identity verification for a client device requesting a first account based on identifying information of the client device and creates the first account based on the identity verification. Further, the device reverification system 100 receives a request for a second account from the client device. In response to the request, the device reverification system 100 can determine whether the identifying information of the client device has changed. For instance, the device reverification system 100 can determined whether the identifying information has changed within a threshold time period (e.g., two years). In some instances, the device reverification system 100 further determines whether the first account and second account are associated with the same third-party services system. Upon determining satisfaction of the reverification requirement(s), the device reverification system 100 can create the second account based on the identity verification used in creating the first account.

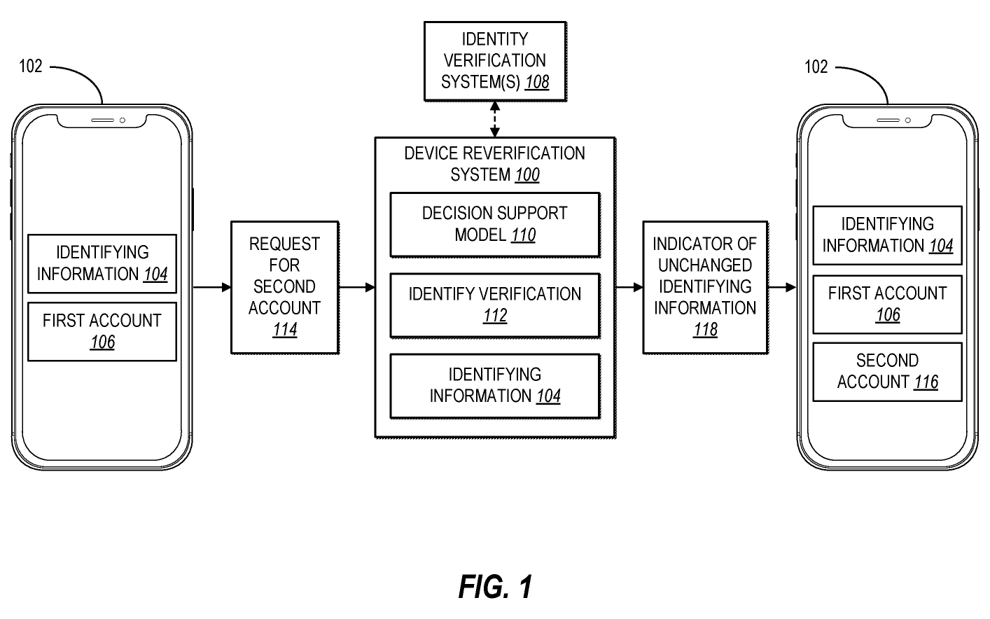

FIG. 1 illustrates an overview diagram of the device reverification system 100 creating a second account for a client device using identifying information and model decisioning used in creating a first account in accordance with one or more embodiments. Indeed, as shown in FIG. 1, a client device 102 is associated with identifying information 104 and a first account 106. In one or more embodiments, the device reverification system 100 uses the identifying information 104 in creating the first account 106 for the client device 102. For instance, in some cases, the device reverification system 100 uses one or more identity verification systems 108 and a decision support model 110 to generate an identity verification 112 for the client device 102 and creates the first account 106 for the client device 102 based on the identity verification 112. In some instances, as will be discuss in more detail below, the device reverification system 100 generates the identity verification 112 using the decision support model 110 based on risk indicators received from the one or more identity verification systems 108. Additionally, in some cases, the identity verification 112 includes a know your customer verification.

Additionally, as shown in FIG. 1, the device reverification system 100 receives a request 114 for a second account from the client device 102. In some cases, the device reverification system 100 receives the request 114 for the second account at or near the same time as receiving a request for the first account 106. In some instances, however, the device reverification system 100 receives the request 114 for the second account at a later time (e.g., after the client device 102 has been verified and the first account 106 has been created).

In one or more embodiments, as indicated by FIG. 1, the device reverification system 100 uses the identifying information 104 and the identity verification 112 used in creating the first account 106 to create a second account 116 for the client device 102 in response to the request 114. Indeed, as shown, the device reverification system 100 maintains access to the identifying information 104 and the identity verification 112 used in creating the first account 106. For instance, in some cases, the device reverification system 100 stores the identifying information 104 and/or the identity verification 112 (e.g., locally on the device hosting the device reverification system 100 or on a remote storage device) and accesses this data upon receiving the request 114. For example, in some embodiments, the device reverification system 100 creates and maintains a device profile for the client device 102 and includes the identifying information 104 and/or the identity verification 112 as part of the device profile.

In some implementations, the device reverification system 100 encrypts the identifying information 104 (or portions thereof) when stored. For instance, in some cases, the device reverification system 100 encrypts particular pieces of the identifying information 104, such as a social security number, to provide additional protections. The device reverification system 100 can further store the encrypted portions of the identifying information 104 separately from unencrypted portions of the identifying information 104.

In one or more embodiments, the device reverification system 100 uses the identifying information 104 used in creating the first account 106 to create the second account 116 by determining whether the identifying information 104 has changed. For instance, the device reverification system 100 can determine whether the identifying information 104 has changed within a threshold period of time (e.g., two years). To illustrate, in some embodiments, the device reverification system 100 determines whether one or more pieces of the identifying information 104 (e.g., a name and/or an address) has changed within the threshold period of time.

As illustrated in FIG. 1, upon determining that the identifying information 104 has remain unchanged within the threshold period of time, the device reverification system 100 generates an indicator 118 that the identifying information 104 has remain unchanged. The device reverification system 100 further generates the second account 116 using the identity verification 112 used in generating the first account 106 based on the indicator 118 generated in response to the request 114 for the second account 116. In other words, the device reverification system 100 reverifies the identity of the client device 102 using the identity verification 112 previously determined (e.g., via the decision support model 110) based on the identifying information 104—which has remained unchanged. The device reverification system 100 creates the second account 116 based on the reverification.

In one or more embodiments, upon determining that the identifying information 104 has changed within the threshold period of time, the device reverification system 100 initiates a new verification process. Indeed, the device reverification system 100 does not use the identity verification 112 to create the second account 116. In some embodiments, the device reverification system 100 generates an additional identity verification based on the identifying information 104—which has changed—using the one or more identity verification systems 108 and the decision support model 110. In some cases, the device reverification system 100 generates a request for additional identifying information of the client device 102 (e.g., information that is not already included in the identifying information 104 of the client device 102). The device reverification system 100 can generate the additional identity verification based on the identifying information 104 and/or the additional identifying information. The device reverification system 100 can further generate the second account 116 based on the additional identity verification.

Thus, in one or more embodiments, the device reverification system 100 reuses the identifying information 104 and model decisioning (e.g., the identity verification 112 generated by the decision support model 110) used to create the first account 106 in creating the second account 116.

In one or more embodiments, the device reverification system 100 provides technological improvements or advantages relative to existing systems. Indeed, existing systems suffer from a number of technical deficiencies when it comes to verifying the identities of client devices, particularly with regard to efficiency. For instance, under existing systems, client devices requesting multiples accounts within a digital system are typically required to undergo separate identity verification for each account, regardless of whether verification was already performed for another account. Such an approach leads to inefficiency as these systems perform multiple identity verifications for the same client device even where the verification requirements are the same or overlap significantly for the different accounts. Further, many existing systems rely on third-party vendors during the verification process. Thus, requiring separate identity verification for separate accounts multiples the communications (e.g., API calls) with these third-party vendors, causing a further consumption of resources (e.g., processing and network bandwidth).

One or more embodiments of the device reverification system 100 provide improvements or advantages over existing systems by improving the efficiency of the verification process. In particular, embodiments of the device reverification system 100 improve the efficiency with which verification is performed for client devices requesting multiple accounts within a digital system. For instance, by reverifying the identity of a client device based on its identifying information remaining unchanged for a threshold time period—rather than by executing a completely new verification process—the device reverification system 100 reduces the resources that are consumed during verification. For example, embodiments of the device reverification system 100 reduce the communications (e.g., API calls) with third-party vendors that are typically executed under existing systems. In particular, in many instances, the device reverification system 100 can reverify the identity of a client device requesting a second account based on the verification performed when creating a first account for the client device to eliminate the need for consuming extract resources via a separate verification process.

Additionally, embodiments of the device reverification system 100 can improve efficiency while maintaining the security of identity verification. For instance, rather than simply removing a security check from the verification process, embodiments of the device reverification system 100 efficiently but securely reuse previous verifications when certain requirements have been met to create new accounts. Indeed, embodiments of the device reverification system 100 introduce a new decision engine and rules to ensure prior security checks are still valid and applicable for subsequent use cases. Further, as mentioned above, embodiments of the device reverification system 100 revert back to a normal verification process if the integrity of the identifying information is in question. As such, the device reverification system 100 leverages the security of previous verifications to seamlessly create new accounts for client devices.

As illustrated by the foregoing discussion, the present disclosure utilizes a variety of terms to describe features and advantages of the device reverification system 100. Additional detail is now provided regarding the meaning of such terms. For example, as used herein, the term “digital system” refers to a collection of digital services and/or features. In particular, a digital system can refer to a digital platform that provides accessibility to one or more services and/or features via a computing device, such as a client device. For instance, a digital system can include a software application that can be downloaded to or otherwise accessed by a computing device.

Additionally, as used herein, the term “account” refers to an account of a digital system that is associated with a client device using the digital system. In particular, an account can refer to an account that is registered with a digital system and mapped to a particular client device. The account can enable the corresponding client device to interact with the digital system, such as by requesting access to services and/or features available through the digital system. In some cases, different accounts (e.g., accounts of different account types) offer access to different sets of services and/or features. Further, in some embodiments, an account includes multiple component accounts (e.g., sub-accounts). In some cases, an account can include an account that is external to the digital system but communicates with the digital system (e.g., communicates with an account of the digital system), access services and/or features of the digital system, or provides access to services and/or features to the digital system.

Further, as used herein, the term “identity” refers to attributes, characteristics, or other descriptors that differentiate a client device from other client devices. In particular, an identity can refer to a collection of attributes, characteristics, or other descriptors that differ from other collections of attributes, characteristics, or other descriptors such that a client device associated with the collection of attributes, characteristics, or other descriptors can be differentiated from other client devices. The identity of a client device can refer to the identity of a user of the client device, of the client device itself, or a combination of the two.

As used herein, the term “identifying information” refers to information related to the identity of a client device. In particular, identifying information can refer to information (e.g., one or more attributes, characteristics, or other descriptors) that is indicative of the identity of a client device. In some cases, identifying information includes information that is indicative of the identity of a user of a client device. To illustrate, identifying information can include, but is not limited to, a first name, a last name, a date of birth, a physical address, an email address, a phone number, a digital photograph, or a government-issued identification card of a user of a client device. In some instances, identifying information includes information about the client device itself, such as a device identifier or serial number. Identifying information can include a single piece of information or a set of information that collectively indicate the identity of a client device.

Additionally, as used herein, the term “identity verification” refers to an indication that the identity of a client device has been verified. In particular, an identity verification can refer to an indication that the identity of a client device is authentic. To illustrate, an identity verification can include an indication that the identifying information of a client device is indicative of an authentic identity. Indeed, in some instances, an identity verification includes an indication that the collection of identifying information of a client device is associated with an authentic identity. In some cases, the device reverification system 100 generates an identity verification upon determining that the identifying information is indicative of at least a threshold level of authenticity. In other words, the device reverification system 100 generates an identity verification upon determining that the identifying information does not raise sufficient concern of fraudulence (e.g., a concern that the identity of the client device is synthetic or that the identity duplicates the identity of another client device). In some cases, an identity verification includes an indication of authenticity generated from one or more risk indicators.

Further, as used herein, the term “decision support model” refers to a computer-implemented model that generates identity verifications for client devices. In particular, a decision support model can refer to a computer-implemented model that generates an identity verification for a client device upon determining that the identifying information of the client device is indicative of an authentic identity. In some cases, a decision support model generates a different indication for a client device (e.g., an indication of non-verification) upon determining that the identifying information of the client device is not indicative of an authentic identity (e.g., is indicative of fraud). In some instances, a decision support model generates an identity verification (or indication of non-verification) for a client device based on one or more risk indicators generated for the client device. In certain implementations, a decision support model includes a machine learning model trained determine whether an identity is authentic or fraudulent (e.g., synthetic or a duplicate).

As used herein, the term “machine learning model” refers to a computer representation that can be tuned (e.g., trained) based on inputs to approximate unknown functions. In particular, the term “machine learning model” can include a model that utilizes algorithms to learn from, and make predictions on, known data by analyzing the known data to learn to generate outputs that reflect patterns and attributes of the known data. For instance, a machine learning model can include, but is not limited to, a neural network (e.g., a convolutional neural network, recurrent neural network or other deep learning network), a decision tree (e.g., a gradient boosted decision tree), association rule learning, inductive logic programming, support vector learning, Bayesian network, regression-based model (e.g., censored regression), principal component analysis, or a combination thereof.

Additionally, as used herein, the term “risk indicator” refers to an indicator of the risk associated with the identity of a client device. In particular, a risk indicator can refer to an indicator of the authenticity or fraudulence of an identity of a client device. For instance, in some cases, a risk indicator indicates the authenticity or fraudulence of an identity based on identifying information (e.g., a piece of identifying information or the collection of identifying information) of a client device. A risk indicator can include a score, a flag, a signal, or other indicator providing a binary indication of risk (e.g., authentic or fraudulent) or an indication of a degree or level of risk (e.g., a level of authenticity or fraudulence).

Further, as used herein, the term “identity verification system” includes a system or platform that evaluates the authenticity of the identity of a client device. In particular, an identity verification system can refer to a hardware or software platform that determines whether the identity of a client device is authentic (or fraudulent) or determines a degree or level of authenticity (or fraudulence). To illustrate, in some cases, an identity verification system includes a system that analyzes the identifying information of a client device and generates one or more risk indicators for the client device based on the analysis.

As used herein, the term “third-party services system” includes a system that is external to a digital system but offers services or features that are accessible to the digital system. In particular, a third-party services system can refer to a hardware or software platform that operates with a digital system to offer one or more of its services or features to accounts of the digital systems. Indeed, in some cases, the digital services and/or features of a digital system include one or more services and/or features of a third-party services system. In some cases, the services and/or features are not directly accessible to the accounts of a digital system but are used in support of services and/or features that are directly accessible to the accounts. In some cases, a digital system provides accessibility (whether direct or indirect) to one or more of the services and/or features of a digital system via a particular account type of the digital system.

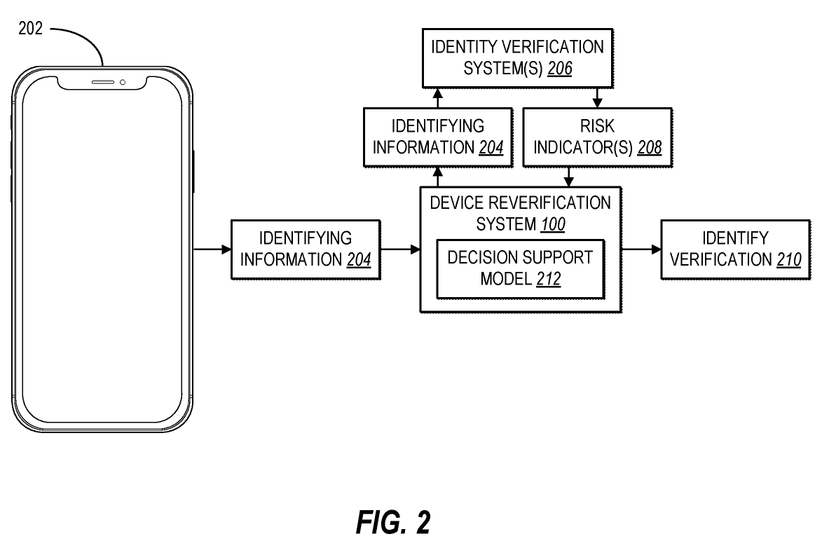

As mentioned above, in one or more embodiments, the device reverification system 100 creates an account for a client device based on an identity verification generated for the client device (e.g., generated in response to a request for the account or in response to a previous request for a different account). FIG. 2 illustrates the device reverification system 100 generating an identity verification for a client device in accordance with one or more embodiments.

As illustrated in FIG. 2, the device reverification system 100 obtains identifying information 204 of a client device 202. In some cases, the device reverification system 100 obtains the identifying information 204 by receiving the identifying information 204 from the client device 202. For instance, in some embodiments, the device reverification system 100 receives the identifying information 204 from the client device 202 as part of a request (e.g., an application) for an account within a digital system.

In some implementations, the device reverification system 100 obtains the identifying information 204 by accessing or otherwise retrieving the identifying information 204. For example, the device reverification system 100 can receive the identifying information 204 prior to receiving a request (e.g., an application) for an account within the digital system (e.g., for creation of a device profile for the digital system) and maintain the identifying information 204 within storage. Upon receiving a request for an account, the device reverification system 100 can retrieve the identifying information 204 from storage and use the identifying information 204 to create the account.

As shown, the device reverification system 100 provides the identifying information 204 to one or more identity verification systems 206. Indeed, the device reverification system 100 can provide the identifying information 204 to a single identity verification system or to multiple identity verification systems. When using multiple identity verification systems, the device reverification system 100 can provide all of the identifying information 204 to each identity verification system or provide a portion of the identifying information 204 to each identity verification system (e.g., the portion used by the identity verification system in its analysis).

As further shown in FIG. 2, the device reverification system 100 receives one or more risk indicators 208 from the one or more identity verification systems 206. In particular, the device reverification system 100 receives at least one risk indicator from each identity verification system used to analyze the identifying information 204 (or a portion thereof). In some cases, the device reverification system 100 receives the one or more risk indicators 208 from the one or more identity verification systems 206 by receiving an aggregated indication. In some instances, however, the device reverification system 100 receives the one or more risk indicators 208 individually.

As illustrated, the device reverification system 100 generates an identity verification 210 for the client device 202 based on the one or more risk indicators 208. In particular, the device reverification system 100 generates the identity verification 210 upon determining that the identity of the client device 202 is authentic (or at least has a threshold level of authenticity) based on the one or more risk indicators 208. As further illustrated, the device reverification system 100 uses a decision support model 212 to generate the identity verification 210. For instance, the device reverification system 100 can provide the one or more risk indicators 208 as input to the decision support model 212 and use the decision support model 212 to generate the identity verification 210 based on an analysis of the one or more risk indicators 208.

In one or more embodiments, the device reverification system 100 (e.g., via the decision support model 212) determines that the identity of the client device 202 is not authentic based on the one or more risk indicators 208. For instance, in some cases, the device reverification system 100 determines that the identity of the client device 202 is synthetic (e.g., composed of artificially created or misappropriated information) or a duplicate of another identity within the digital system. In such cases, rather than generating the identity verification 210, the device reverification system 100 (e.g., via the decision support model 212) generates an indication of non-verification for the client device 202.

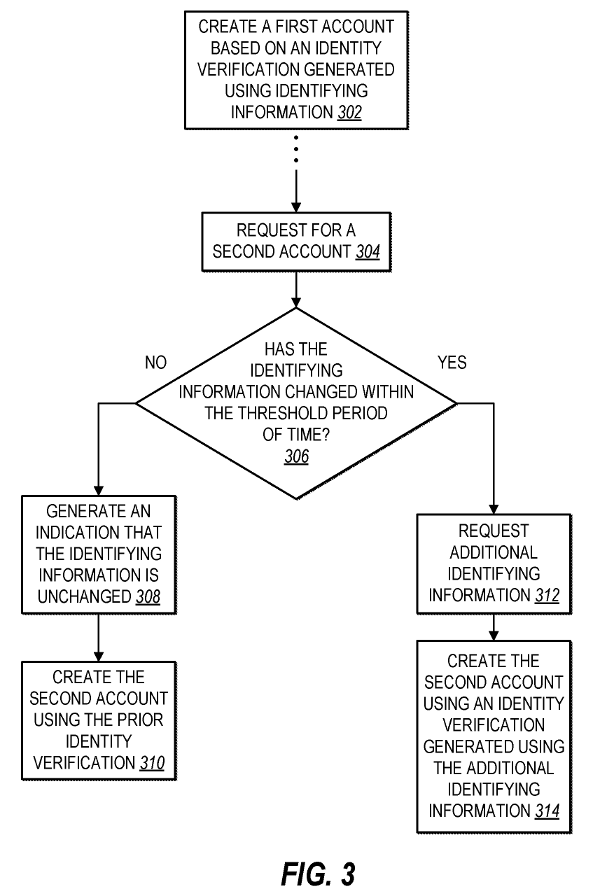

As mentioned, in one or more embodiments, the device reverification system 100 creates an account for a client device based on an identity verification generated in creating another account for the client device. In other words, in some cases, the device reverification system 100 reuses an identity verification previously generated when creating a first account to create a second account. FIG. 3 illustrates an example flowchart of the device reverification system 100 reusing the identity verification generated for a first account to create a second account for a client device in accordance with one or more embodiments.

As illustrated in FIG. 3, the device reverification system 100 performs an act 302 of creating a first account for a client device based on an identity verification generated using identifying information of the client device. To illustrate, the device reverification system 100 can determine (e.g., via a decision support model) that an identity of a client device is authentic (or at least has a threshold level of authenticity). For instance, in some cases, the device reverification system 100 determines the authenticity of the identity in response to receiving a request from the client device for the first account within a digital system. The device reverification system 100 can generate (e.g., via the decision support model) an identity verification for the client device based on the authenticity. The device reverification system 100 can further create the first account for the client device based on the identity verification (e.g., based on the identity being verified as authentic or at least having a threshold level of authenticity).

Additionally, as shown in FIG. 3, the device reverification system 100 receives a request 304 for a second account within the digital system. In some cases, the device reverification system 100 receives the request 304 for the second account at the same time or near the time of receiving a request for the first account. In some cases, however, the device reverification system 100 receives the request 304 for the second account at a time much later than when the first account was created for the client device.

As further illustrated, the device reverification system 100 performs a check 306 to determine whether the identifying information of the client device has changed within a threshold period of time. Indeed, as previously mentioned, in certain implementations, the device reverification system 100 uses the identifying information of the client device when creating the first account within the digital system. For instance, the device reverification system 100 can provide the identifying information to one or more identity verification systems, receive one or more risk indicators generated from the identifying information in return, and generate (e.g., via a decision support model) the identity verification used in creating the first account. Thus, in some cases, upon receiving the request 304 for the second account, the device reverification system 100 determines whether the identifying information has changed. In particular, as indicated, the device reverification system 100 determines whether the identifying information has changed within a threshold period of time (e.g., two years).

In some instances, the device reverification system 100 establishes the threshold period of time, such as establishing a default period of time. In some cases, however, the threshold period of time is configurable. Thus, the device reverification system 100 can the threshold period of time in accordance with input. In some implementations, the device reverification system 100 establishes the threshold period of time to optimizes the security of reusing identity verifications when creating new accounts for client devices.

In one or more embodiments, in determining whether the identifying information of the client device has changed, the device reverification system 100 determines whether any piece of the identifying information has changed. Indeed, in some cases, upon determining that a single piece of information (e.g., the last name or address) has changed, the device reverification system 100 determines that the identifying information has changed. In some instances, the device reverification system 100 only determines that the identifying information has changed if certain pieces of the identifying information have changed, or a certain amount of the identifying information has changed.

As shown in FIG. 3, if the device reverification system 100 determines that the identifying information of the client device has not changed within the threshold period of time, the device reverification system 100 performs an act 308 of generating an indication that the identifying information is unchanged. Further, the device reverification system 100 performs an act 310 of creating the second account for the client device using the prior identity verification. Thus, the device reverification system 100 creates the second account for the client device using the identity verification generated when creating a first account for the client device and based on the indicator generated in response to the request 304 for the second account.

As further shown in FIG. 3, if the device reverification system 100 determines that the identifying information of the client device has changed within the threshold period of time, the device reverification system 100 performs an act 312 of requesting additional identifying information from the client device. The device reverification system 100 further performs an act 314 of creating the second account using an identity verification generated using the additional identifying information. In some cases, the device reverification system 100 generates the identity verification using the changed identifying information and the additional identifying information.

To illustrate, in one or more embodiments, the identifying information used in creating the first account for the client device includes at least one of a first name, a last name, a date of birth, an email address, or a phone number associated with the client device (e.g., associated with a user of the client device). Upon determining that the identifying information has changed within the threshold period of time, the device reverification system 100 generates a request for at least one of a digital photograph of a user associated with the identifying information of the client device or a government-issued identification card associated with the client device. The device reverification system 100 can use this additional identifying information to perform an additional verification of the identity of the client device. In some cases, the device reverification system 100 uses the additional identifying information in combination with the changed identifying information. For instance, in some cases, the device reverification system 100 provides the additional identifying information (and the changed identifying information) to one or more identity verification systems, receives one or more risk indicators generated based on the information, and generates (e.g., using a decision support model) an identity verification (or indication of non-verification) based on the one or more risk indicators.

By reusing the identity verification used in creating the first account (e.g., where the identifying information has not changed within the threshold period of time), the device reverification system 100 reduces the demand on resources typically required under existing systems. Indeed, the device reverification system 100 relies on a previous verification of the identity of the client device to reverify the client device for a new account without the need to complete a separate verification process. In other words, the device reverification system 100 reverifies the identity of the client device without executing the process that leads to the generation of a separate identity verification. As such, the device reverification system 100 avoids consuming resources that would otherwise be required to communicate with identity verification systems and to implement a decision support model.

Further, the device reverification system 100 improves the efficiency of reverifying the identity of the client device without sacrificing security. Indeed, rather than merely dropping a security measure (e.g., the creation of a new identity verification) when creating the second account, the device reverification system 100 leverages a previous verification for that client device. The device reverification system 100 incorporates a new decision engine withing the verification process to determine whether the identifying information has changed within a threshold time period, ensuring that the identifying information previously used to verify the identity of the client device is still reliable.

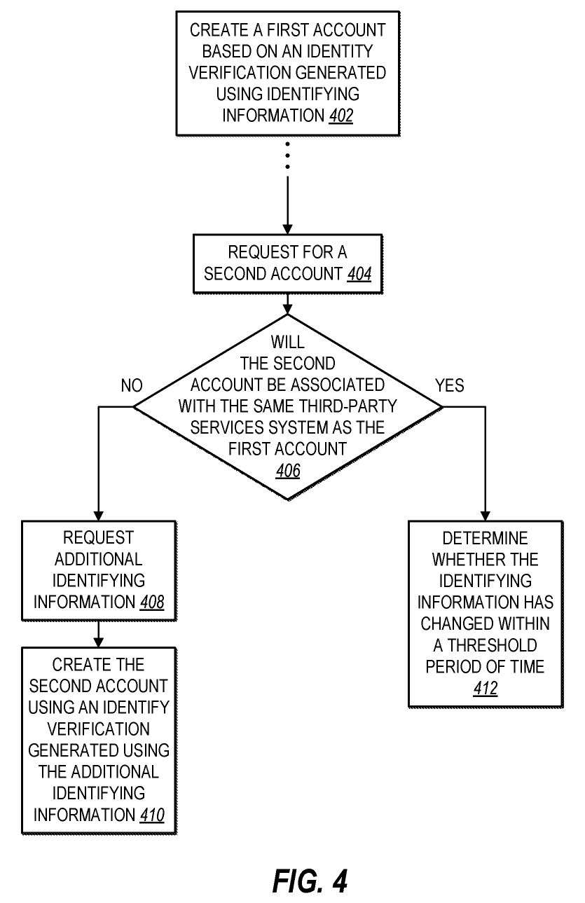

As further mentioned above, in some implementations, the device reverification system 100 further determines whether a new account requested by a client device is associated with the same third-party services system as an existing account of the client device in response to the request. In particular, the device reverification system 100 can determine the third-party services system associated with each account as part of the reverification process. FIG. 4 illustrates an example flowchart of the device reverification system 100 determining the third-party services system associated with client devices as part of a reverification process in accordance with one or more embodiments.

As illustrated in FIG. 4, the device reverification system 100 performs an act 402 of creating a first account for a client device based on an identity verification generated using identifying information of the client device. Further, the device reverification system 100 receives a request 404 for a second account within the digital system.

As further shown in FIG. 4, the device reverification system 100 performs a check 406 to determine whether the second account will be associated with the same third-party service as the first account of the client device. Indeed, in some cases, a digital system implemented by the device reverification system 100 uses or works with multiple third-party services systems. In some cases, one or more of the account types offered by the digital system are associated with (e.g., use the features and/or services) of one third-party services system while one or more of the other account types offered by the digital system are associated with (e.g., use the features and/or services) of a different third-party services system. Further, in certain implementations, each third-party services system implements a separate set of requirements (e.g., security measures) for creating and/or using an account that accesses its services and/or features. Thus, by performing the check 406, the device reverification system 100 ensures that the requirements of a third-party services system are met when creating an associated account for a client device based on a previous verification.

To illustrate the check 406, in one or more embodiments, the device reverification system 100 determines the third-party services system that is associated with the first account previously created for the client device and the third-party services system associated with the second account to be created for the client device. The device reverification system 100 further determines whether the third-party services systems are the same or different. In other words, the device reverification system 100 determines whether the same third-party services system is associated with the first account and will be associated with the second account.

As shown in FIG. 4, if the device reverification system 100 determines that the second account will not be associated with the same third-party services system as the first account (i.e., each account will be associated with a different third-party services system), the device reverification system 100 performs an act 408 of requesting additional identifying information from the client device. For instance, in some cases, the device reverification system 100 generates a request for identifying information that is required by the third-party services system that will be associated with the second account and is not already included in the identifying information of the client device. As one example, as discussed above, the device reverification system 100 can request that the additional identifying information include at least one of a digital photograph of a user associated with the identifying information of the client device or a government-issued identification card associated with the client device.

As shown, the device reverification system 100 further performs an act 410 of creating the second account using an identity verification generated using the additional identifying information. In some cases, the device reverification system 100 generates the identity verification using the identifying information and the additional identifying information.

As further shown in FIG. 4, if the device reverification system 100 determines that the second account will be associated with the same third-party services system as the first account, the device reverification system 100 performs an act 412 of determining whether the identifying information of the client device has changed within a threshold period of time. In particular, the device reverification system 100 moves on creating the second account for the client device based on whether the identifying information has changed within the threshold period of time as discussed above with reference to FIG. 3.

Indeed, as suggested by FIG. 4, one or more embodiments of the device reverification system 100 use the check 406 as an initial determination that additional identifying information is needed or that reverification can proceed by checking on whether the identifying information has changed. In some embodiments, however, the device reverification system 100 determines whether the identifying information has changed and then performs the check 406. In some instances, the device reverification system 100 performs the checks at or near the same time.

By determining whether the third-party services system for a new account will be the same as for an account that has already been created, the device reverification system 100 implements an additional security check for leveraging the previous verification of a client device identity. In particular, embodiments of the device reverification system 100 ensure that verification performed under the standards of one third-party services system is not reused to create another account if the verification potentially fails the standards of another third-party services system for that account. As such, one or more embodiments of the device reverification system 100 efficiently reverify client device identities (e.g., by reusing previous verifications) while securely maintaining the standards of supporting third-party services systems.

In some cases, the device reverification system 100 continues to monitor the identifying information of a client device and/or monitor risk indicators that correspond to the client device to ensure that the client device does not engage in any fraudulent activity. For instance, in some cases, the device reverification system 100 receives a flag or other signal from an identity verification system that indicates the client device (or the corresponding identity) has engaged in suspicious or fraudulent activity. Upon receiving the flag/signal, the device reverification system 100 can determine whether to deny the creation of an account or to suspend or deactivate an account that has already been created for the client device. In some embodiments, the device reverification system 100 monitors the activity of the client device on the digital system. For instance, the device reverification system 100 can determine whether the account activity of the client device is suspicious and determine to take action against the client device based on this activity.

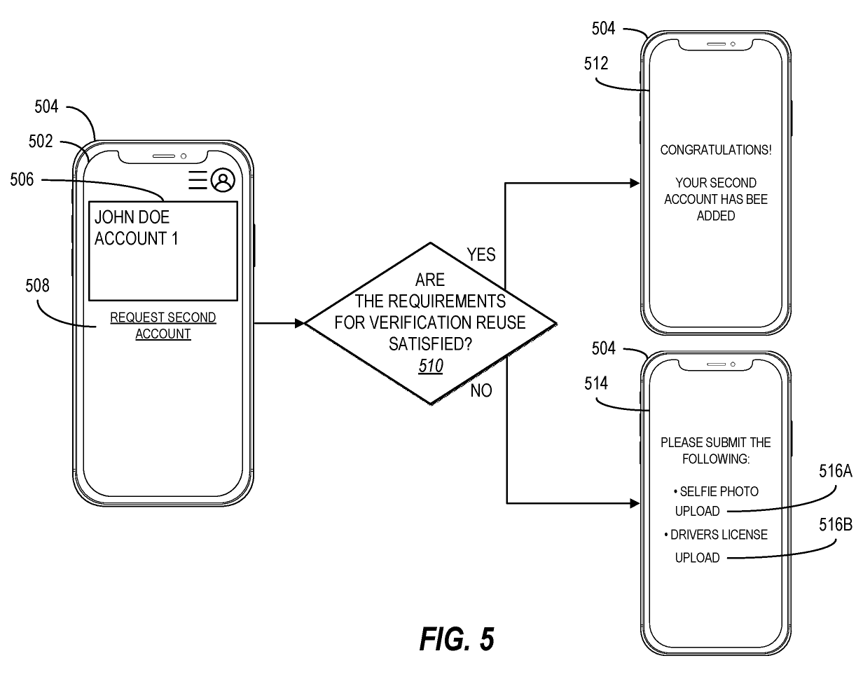

In one or more embodiments, the device reverification system 100 causes a client device requesting an account within a digital system to display different graphical user interfaces based on whether a previous verification for the client device can be used in creating the account. FIG. 5 illustrates graphical user interfaces displayed by a client device based on reuse of a previous verification in accordance with one or more embodiments.

As illustrated in FIG. 5, the device reverification system 100 provides a graphical user interface 502 for display on a client device 504. The graphical user interface 502 displays an indication 506 of a first account of the client device within a digital system. In some cases, the indication 506 includes an interactive element, and the device reverification system 100 causes the client device 504 to display information regarding the first account in response to detecting a user interaction with the indication 506. In some cases, the first account includes an account that was previously created in response to a request for the first account and based on an identity verification generated upon receiving the request.

As further shown in FIG. 5, the graphical user interface 502 also displays a selectable option 508 for requesting a second account within the digital system. Indeed, in some cases, in response to a user selection of the selectable option 508, the device reverification system 100 receives a request from the client device 504 for the second account. In some implementations, the device reverification system 100 offers a plurality of account types. Thus, in some instances, the device reverification system 100 presents the selectable option 508 for requesting the second account in a different form (e.g., a drop-down menu or a list of available account types).

As shown, upon a selection of the selectable option 508 (e.g., upon receiving a request for the second account), the device reverification system 100 performs a check 510 to determine whether the requirements for verification reuse have been satisfied. In other words, the device reverification system 100 determines whether the requirements have been met such that the identity verification used in creating the first account of the client device 504 can be used in creating the second account. To illustrate, in one or more embodiments, the device reverification system 100 determines whether the identifying information of the client device 504 has changed within a threshold period of time. In some embodiments, the device reverification system 100 further determines whether the second account will be associated with the same third-party services system as the first account.

If the requirements for reverification reuse are satisfied, the device reverification system 100 causes the client device 504 to display a graphical user interface 512 indicating that the second account has been created. Indeed, as discussed above, upon determining that the requirements for verification reuse have been satisfied, the device reverification system 100 creates the second account for the client device 504. In particular, the device reverification system 100 uses the identity verification generated when creating the first account to create the second account. Thus, the device reverification system 100 creates the second account without requiring additional information from the client device 504 and causes the client device 504 to display the graphical user interface 512 to indicate this.

As further shown in FIG. 5, if the requirements for reverification reuse are not satisfied, the device reverification system 100 causes the client device 504 to display a graphical user interface 514 requesting additional identifying information from the client device 504. In particular, as suggested above, upon determining that the identifying information of the client device 504 has changed within a threshold period of time and/or determining that the second account will be associated with a different third-party services system than the first account, the device reverification system 100 generates a request for additional identifying information. Thus, the device reverification system 100 causes the client device 504 to display the graphical user interface 514 with the request.

As illustrated, the graphical user interface includes a first selectable option 516a for submitting a first piece of additional identifying information (e.g., a digital photo of the user of the client device 504) and a second selectable option 516b for submitting a second piece of additional identifying information (e.g., a government-issued identification card associated with the client device 504). The amount of additional identifying information or the particular pieces of additional identifying information that are requested vary in different embodiments. In some cases, upon selection of one of the selectable options, the device reverification system 100 modifies the graphical user interface 514 (or provides a new graphical user interface) to facilitate submission of the corresponding piece of additional identifying information. For instance, upon detecting a selection of the first selectable option 516a, the device reverification system 100 can activate a camera application of the client device 504 to facilitate the capture of a digital photo. Alternatively, the device reverification system 100 can access a photo application of the client device 504 to facilitate submission of a digital photo that has already been captured and stored.

Thus, in one or more embodiments, the device reverification system 100 controls the display of the client device 504 based on the satisfaction of the requirements for verification reuse (i.e., reverification requirements). If the requirements have been satisfied, the device reverification system 100 creates the requested second account without additional user interaction.

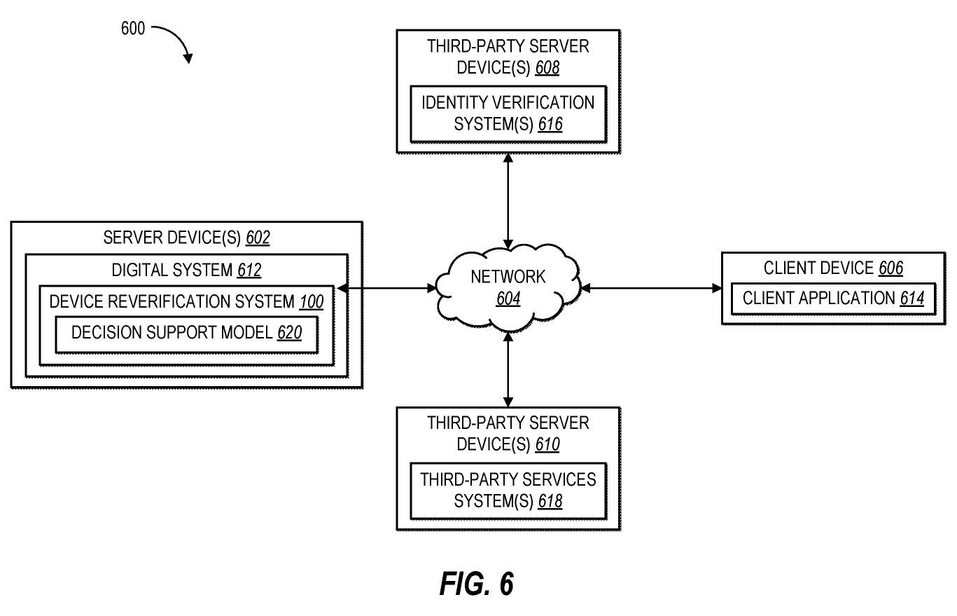

Additional detail regarding the environment within which one or more embodiments of the device reverification system 100 operates. In particular, FIG. 6 illustrates a block diagram of a system environment (“environment”) 600 for implementing the device reverification system 100 in accordance with one or more embodiments. As illustrated in FIG. 6, the environment 600 includes a server device(s) 602, a network 604, a client device 606, a third-party server device(s) 608 and an additional third-party server device(s) 610.

Although the environment 600 of FIG. 6 is depicted as having a particular number of components, the environment 600 can have any number of additional or alternative components (e.g., a different number of server devices, client devices, third-party server devices, or other components in communication with the device reverification system 100 via the network 604). Similarly, although FIG. 6 illustrates a particular arrangement of the server device(s) 602, the network 604, the client device 606, the third-party server device(s) 608, and the additional third-party server device(s) 610, various additional arrangements are possible.

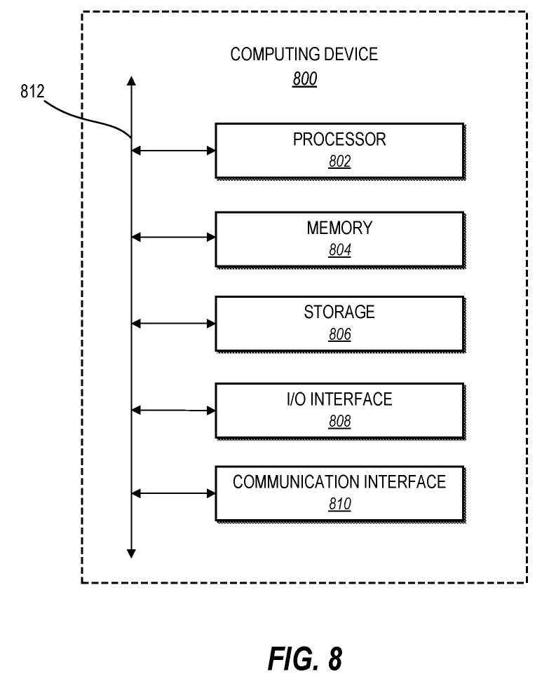

The server device(s) 602, the network 604, the client device 606, the third-party server device(s) 608, and the additional third-party server device(s) 610 can be communicatively coupled with each other either directly or indirectly (e.g., through the network 604 as discussed in greater detail below in relation to FIG. 8). Moreover, the server device(s) 602, the client device 606, the third-party server device(s) 608, and the additional third-party server device(s) 610 may include a variety of computing devices (including one or more computing devices as discussed in greater detail with relation to FIG. 8).

As mentioned, the environment 600 includes the server device(s) 602. In one or more embodiments, the server device(s) 602 generates, stores, receives, and/or transmits digital data, including digital data related to the creation and management of accounts of a digital system 612. For example, the server device(s) 602 can receive, from the client device 606, a request to create one or more accounts within the digital system 612 and provide notifications regarding the status of the accounts (or a request for additional identifying information) in return. In one or more embodiments, the server device(s) 602 comprises a data server. In some embodiments, the server device(s) 602 comprises a communication server or a web-hosting server.

As shown, the server device(s) 602 includes the digital system 612. In one or more embodiments, the digital system 612 provides a collection of digital services and/or features. Further, the digital system 612 can manage associated accounts. For example, the digital system 612 can create accounts, verify the identities of users applying for accounts, close or suspend accounts, and/or provide at least some of the digital services to each of the accounts.

Additionally, the server device(s) 602 include the device reverification system 100. In particular, in one or more embodiments, the device reverification system 100 utilizes the server device(s) 602 to create accounts for client devices within the digital system 612. For example, in some embodiments, the device reverification system 100 receives, via the server device(s) 602, a request to create a second account from the client device 606, which already has a first account within the digital system 612. Via the server device(s) 602, the device reverification system 100 can determine whether the identifying information of the client device 606 has changed within a threshold period of time. Further, the device reverification system 100 can determine whether the first account and the second account will be associated with the same third-party services system. Upon determining satisfaction of these requirements, the device reverification system 100, via the server device(s) 602, can create the second account for the client device 606 without the need for executing a separate verification process. In particular, the device reverification system 100 can create the second account using an identity verification generated (e.g., via a decision support model 620) when creating the first account. Upon determining that the requirements have not been satisfied, the device reverification system 100, via the server device(s) 602, can generate and provide a request for additional identifying information.

In one or more embodiments, the client device 606 includes a computing device that can access the digital system 612 (e.g., to request accounts or utilize the services and/or feature offered). For example, in some implementations, the client device 606 includes at least one of a smartphone, a tablet, a desktop computer, a laptop computer, a head-mounted-display device, or other electronic device. In some instances, the client device 606 includes one or more applications (e.g., the client application 614) that can access the digital system 612 (e.g., to request accounts or utilize the services and/or feature offered). For example, in some embodiments, the client application 614 includes a software application installed on the client device 606. In other cases, however, the client application 614 includes a software application hosted on the server device(s) 602 (and supported by the digital system 612), which is accessible by the client device 606 through another application, such as a web browser.

In one or more embodiments, the third-party server device(s) 608 interacts with the device reverification system 100, via the server device(s) 602, over the network 604. For example, the third-party server device(s) 608 can host one or more identity verification systems 616 that verify a client device identity in response to a request for an account. For instance, the one or more identity verification systems 616 analyze identifying information of the client device and generate one or more risk indicators based on the analysis. Accordingly, the one or more identity verification systems 616 can transmit the one or more risk indicators to the device reverification system 100 over the network 604.

Additionally, in one or more embodiments, the additional third-party server device(s) 610 interacts with the device reverification system 100, via the server device(s) 602, over the network 604. For example, the additional third-party server device(s) 610 can host one or more third-party services systems 618 that offer additional services and/or features to accounts of the digital system 612. In some cases, the one or more third-party services systems 618 offer services and/or features to particular account types of the digital system 612.

The device reverification system 100 can be implemented in whole, or in part, by the individual elements of the environment 600. Indeed, although FIG. 6 illustrates the device reverification system 100 implemented with regard to the server device(s) 602, different components of the device reverification system 100 can be implemented by a variety of devices within the environment 600. For example, one or more (or all) components of the device reverification system 100 can be implemented by a different computing device (e.g., the client device 606) or a separate server device from the server device(s) 602 hosting the digital system 612.

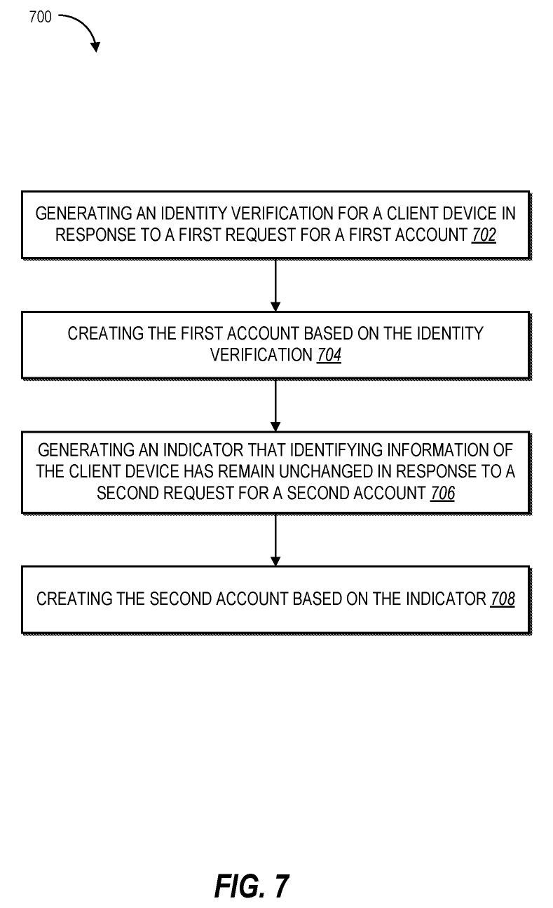

FIGS. 1-6, the corresponding text and the examples provide a number of different methods, systems, devices, and non-transitory computer-readable media of the device reverification system 100. In addition to the foregoing, one or more embodiments can also be described in terms of flowcharts comprising acts for accomplishing particular results, as shown in FIG. 7. FIG. 7 may be performed with more or fewer acts. Further, the acts may be performed in different orders. Additionally, the acts described herein may be repeated or performed in parallel with one another or in parallel with different instances of the same or similar acts.

FIG. 7 illustrates a flowchart of a series of acts 700 for reusing a previously generated identity verification for a client device in creating a new account for the client device within a digital system in accordance with one or more embodiments. FIG. 7 illustrates acts according to one embodiment, but alternative embodiments may omit, add to, reorder, and/or modify any of the acts shown in FIG. 7. In some implementations, the acts of FIG. 7 are performed as part of a computer-implemented method. Alternatively, a non-transitory computer-readable medium can store instructions thereon that, when executed by at least one processor, cause a computing device to perform the acts of FIG. 7. In some embodiments, a system performs the acts of FIG. 7. For example, in one or more embodiments, a system includes at least one processor. The system further includes a non-transitory computer-readable medium storing instructions that, when executed by the at least one processor, cause the system to perform the acts of FIG. 7.

The series of acts 700 includes an act 702 for generating an identity verification for a client device in response to a first request for a first account. For example, in one or more embodiments, the act 702 involves generating, using a decision support model and in response to receiving a first request from a client device for a first account within a digital system, an identity verification based on identifying information of the client device.

The series of acts 700 also includes an act 704 for creating the first account based on the identity verification. In particular, in some embodiments, the act 704 involves creating the first account within the digital system for the client device based on the identity verification.

Additionally, the series of acts 700 includes an act 706 for generating an indicator that identifying information of the client device has remain unchanged in response to a second request for a second account. To illustrate, in some implementations, the act 706 involves generating, in response to receiving a second request from the client device for a second account within the digital system, an indicator that the identifying information of the client device has remain unchanged for a threshold period of time.

Further, the series of acts 700 includes an act 708 for creating the second account based on the indicator. For example, in some cases, the act 708 involves creating the second account within the digital system for the client device using the identity verification generated in response to the first request based on the indicator generated in response to the second request.

In one or more embodiments, creating the first account based on the identity verification generated in response to the first request comprises creating the first account based on a know your customer verification generated in response to the first request. Additionally, in some cases, creating the second account using the identity verification generated in response to the first request based on the indicator generated in response to the second request comprises creating the second account based on the know your customer verification generated in response to the first request without generating an additional know your customer verification in response to the second request. In some embodiments, the device reverification system 100 further receives, via one or more identity verification systems, one or more risk indicators for the client device based on the identifying information of the client device. Thus, in some instances, generating the identity verification using the decision support model based on the identifying information of the client device comprises generating the identity verification using the decision support model based on the one or more risk indicators.

In certain embodiments, generating the indicator that the identifying information of the client device has remain unchanged for the threshold period of time comprises generating the indicator that the identifying information of the client device has remain unchanged for at least two years.

In one or more embodiments, the device reverification system 100 further creates a third account within the digital system for a second client device based on a second identity verification generated from identifying information of the second client device; receives, from the second client device, an additional request to create a fourth account within the digital system; and generates, in response to the additional request to create the fourth account, a request for additional identifying information of the second client device based on determining that the identifying information of the second client device has changed within the threshold period of time. In some embodiments, the device reverification system 100 generates the second identity verification from the identifying information of the second client device by generating, using the decision support model, the second identity verification from at least one of a first name, a last name, a date of birth, an email address, or a phone number associated with the second client device. Thus, in some instances, generating the request for the additional identifying information of the second client device comprises generating the request for at least one of a digital photograph of a user associated with the identifying information of the second client device or a government-issued identification card associated with the second client device. In some implementations, the device reverification system 100 receives the additional identifying information of the second client device; generates, using the decision support model, a third identity verification based on the additional identifying information of the second client device; and creates the fourth account within the digital system for the second client device based on the second identity verification.

In one or more embodiments, the device reverification system 100 further creates a third account within the digital system for a second client device based on a second identity verification generated from identifying information of the second client device, the third account being associated with a third-party services system; receives, from the second client device, an additional request to create a fourth account within the digital system, the fourth account being associated with an additional third-party services system; and generates, in response to the additional request to create the fourth account, a request for additional identifying information of the second client device based on determining that the third-party services system and the additional third-party services system differ.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., the server device(s) 602, the client device 606, the third-party server device(s) 608, and/or the additional third-party server device(s) 610). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

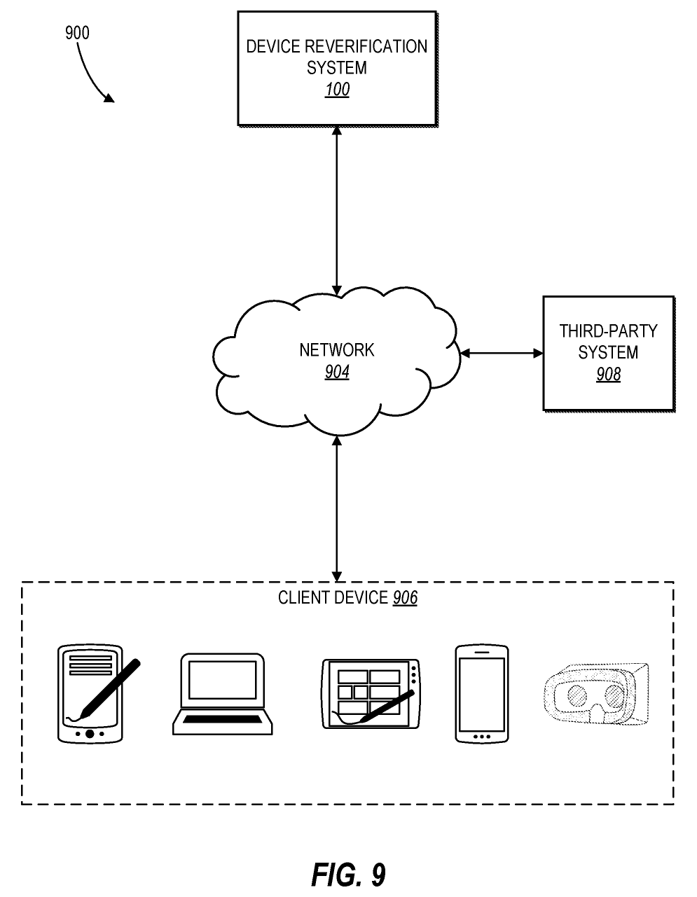

FIG. 9 illustrates an example network environment 900 of the device reverification system 100. The network environment 900 includes client device(s) 906 (e.g., client device 606), a device reverification system 100, and third-party system(s) 908 connected to each other by network(s) 904. Although FIG. 9 illustrates a particular arrangement of the client device(s) 906, the device reverification system 100, the third-party system(s) 908, and the network(s) 904, this disclosure contemplates any suitable arrangement of the client device(s) 906, the device reverification system 100, the third-party system(s) 908, and the network(s) 904. As an example, and not by way of limitation, two or more of the client device(s) 906, the device reverification system 100, and the third-party system(s) 908 communicate directly, bypassing the network(s) 904. As another example, two or more of the client device(s) 906, the device reverification system 100, and the third-party system(s) 908 may be physically or logically co-located with each other in whole or in part.

Moreover, although FIG. 9 illustrates a particular number of the client device(s) 906, the device reverification system 100, the third-party system(s) 908, and the network(s) 904, this disclosure contemplates any suitable number of the client device(s) 906, device reverification systems, the third-party system(s) 908, and the network(s) 904. As an example, and not by way of limitation, network environment 900 may include multiple client devices, inter-network facilitation systems, third-party systems, and/or networks.

This disclosure contemplates any suitable network for the network(s) 904. As an example, and not by way of limitation, one or more portions of the network(s) 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network(s) 904 may include one or more networks.

Links may connect the client device(s) 906, device reverification system 100, and the third-party system(s) 908 to the network(s) 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device(s) 906 may be an electronic device including hardware, software, or embedded logic components or a combination of two or more such components and capable of carrying out the appropriate functionalities implemented or supported by the client device(s) 906. As an example, and not by way of limitation, the client device(s) 906 may include any of the computing devices discussed above in relation to FIG. 8. The client device(s) 906 may enable a network user at the client device(s) 906 to access the network(s) 904. The client device(s) 906 may enable its user to communicate with other users at other client devices of the client device(s) 906.

In particular embodiments, the client device(s) 906 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device(s) 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device(s) 906 one or more Hyper Text Markup Language (“HTML”) files responsive to the HTTP request. The client device(s) 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, device reverification system 100 may be a network-addressable computing system that can interface between two or more computing networks or servers associated with different entities such as financial institutions (e.g., banks, credit processing systems, ATM systems, or others). In particular, the device reverification system 100 can send and receive network communications (e.g., via the network(s) 904) to link the third-party system(s) 908. For example, the device reverification system 100 may receive authentication credentials from a user to link the third-party system(s) 908 such as an online bank account, credit account, debit account, or other financial account to a user account within the device reverification system 100. The device reverification system 100 can subsequently communicate with the third-party system(s) 908 to detect or identify balances, transactions, withdrawal, transfers, deposits, credits, debits, or other transaction types associated with the third-party system(s) 908. The device reverification system 100 can further provide the aforementioned or other financial information associated with the third-party system(s) 908 for display via the client device(s) 906. In some cases, the device reverification system 100 links more than one of the third-party system(s) 908, receiving account information for accounts associated with each respective third-party system of the third-party system(s) 908 and performing operations or transactions between the different systems via authorized network connections.

In particular embodiments, the device reverification system 100 may interface between an online banking system and a credit processing system via the network(s) 904. For example, the device reverification system 100 can provide access to a bank account of the third-party system(s) 908 and linked to a user account within the device reverification system 100. Indeed, the device reverification system 100 can facilitate access to, and transactions to and from, the bank account of the third-party system(s) 908 via a client application of the device reverification system 100 on the client device(s) 906. The device reverification system 100 can also communicate with a credit processing system, an ATM system, and/or other financial systems (e.g., via the network(s) 904) to authorize and process credit charges to a credit account, perform ATM transactions, perform transfers (or other transactions) across accounts of different third-party systems of the third-party system(s) 908, and to present corresponding information via the client device(s) 906.

In particular embodiments, the device reverification system 100 includes a model for approving or denying transactions. For example, the device reverification system 100 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the device reverification system 100 and/or the third-party system(s) 908), the device reverification system 100 can utilize the transaction approval machine learning model to generate a prediction (e.g., a percentage likelihood) of approval or denial of a transaction (e.g., a withdrawal, a transfer, or a purchase) across one or more networked systems.

The device reverification system 100 may be accessed by the other components of network environment 900 either directly or via the network(s) 904. In particular embodiments, the device reverification system 100 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the device reverification system 100 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device(s) 906, or a device reverification system 100 to manage, retrieve, modify, add, or delete, the information stored in a data store.

In particular embodiments, the device reverification system 100 may provide users with the ability to take actions on various types of items or objects, supported by the device reverification system 100. As an example, and not by way of limitation, the items and objects may include financial institution networks for banking, credit processing, or other transactions, to which users of the device reverification system 100 may belong, computer-based applications that a user may use, transactions, interactions that a user may perform, or other suitable items or objects. A user may interact with anything that is capable of being represented in the device reverification system 100 or by an external system of a third-party system, which is separate from device reverification system 100 and coupled to the device reverification system 100 via the network(s) 904.

In particular embodiments, the device reverification system 100 may be capable of linking a variety of entities. As an example, and not by way of limitation, the device reverification system 100 may enable users to interact with each other or other entities, or to allow users to interact with these entities through an application programming interfaces (“API”) or other communication channels.

In particular embodiments, the device reverification system 100 may include a variety of servers, sub-systems, programs, modules, logs, and data stores. In particular embodiments, the device reverification system 100 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The device reverification system 100 may also include suitable components such as network interfaces, security mechanisms, load balancers, failover servers, management-and-network-operations consoles, other suitable components, or any suitable combination thereof. In particular embodiments, the device reverification system 100 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the device reverification system 100 and the client device(s) 906. An action logger may be used to receive communications from a web server about a user’s actions on or off the device reverification system 100. In conjunction with the action log, a third-party-content-object log may be maintained of user exposures to third-party-content objects. A notification controller may provide information regarding content objects to the client device(s) 906. Information may be pushed to the client device(s) 906 as notifications, or information may be pulled from the client device(s) 906 responsive to a request received from the client device(s) 906. Authorization servers may be used to enforce one or more privacy settings of the users of the device reverification system 100. A privacy setting of a user determines how particular information associated with a user can be shared. The authorization server may allow users to opt in to or opt out of having their actions logged by the device reverification system 100 or shared with other systems, such as, for example, by setting appropriate privacy settings. Third-party-content-object stores may be used to store content objects received from third parties. Location stores may be used for storing location information received from the client device(s) 906 associated with users.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, using a decision support model and in response to receiving a first request from a client device for a first account within a digital system, an identity verification based on identifying information of the client device;
creating the first account within the digital system for the client device based on the identity verification;
generating, in response to receiving a second request from the client device for a second account within the digital system, an indicator that the identifying information of the client device has remain unchanged for a threshold period of time; and
creating the second account within the digital system for the client device using the identity verification generated in response to the first request based on the indicator generated in response to the second request.

2. The computer-implemented method of claim 1, wherein:
creating the first account based on the identity verification generated in response to the first request comprises creating the first account based on a know your customer verification generated in response to the first request; and
creating the second account using the identity verification generated in response to the first request based on the indicator generated in response to the second request comprises creating the second account based on the know your customer verification generated in response to the first request without generating an additional know your customer verification in response to the second request.

3. The computer-implemented method of claim 1,
further comprising receiving, via one or more identity verification systems, one or more risk indicators for the client device based on the identifying information of the client device,
wherein generating the identity verification using the decision support model based on the identifying information of the client device comprises generating the identity verification using the decision support model based on the one or more risk indicators.

4. The computer-implemented method of claim 1, wherein generating the indicator that the identifying information of the client device has remain unchanged for the threshold period of time comprises generating the indicator that the identifying information of the client device has remain unchanged for at least two years.

5. The computer-implemented method of claim 1, further comprising:
creating a third account within the digital system for a second client device based on a second identity verification generated from identifying information of the second client device;
receiving, from the second client device, an additional request to create a fourth account within the digital system; and
generating, in response to the additional request to create the fourth account, a request for additional identifying information of the second client device based on determining that the identifying information of the second client device has changed within the threshold period of time.

6. The computer-implemented method of claim 5,
further comprising generating the second identity verification from the identifying information of the second client device by generating, using the decision support model, the second identity verification from at least one of a first name, a last name, a date of birth, an email address, or a phone number associated with the second client device,
wherein generating the request for the additional identifying information of the second client device comprises generating the request for at least one of a digital photograph of a user associated with the identifying information of the second client device or a government-issued identification card associated with the second client device.

7. The computer-implemented method of claim 5, further comprising:
receiving the additional identifying information of the second client device;
generating, using the decision support model, a third identity verification based on the additional identifying information of the second client device; and
creating the fourth account within the digital system for the second client device based on the second identity verification.

8. The computer-implemented method of claim 1, further comprising:
creating a third account within the digital system for a second client device based on a second identity verification generated from identifying information of the second client device, the third account being associated with a third-party services system;
receiving, from the second client device, an additional request to create a fourth account within the digital system, the fourth account being associated with an additional third-party services system; and
generating, in response to the additional request to create the fourth account, a request for additional identifying information of the second client device based on determining that the third-party services system and the additional third-party services system differ.

9. A system comprising:
at least one processor; and
a non-transitory computer-readable medium storing instructions that, when executed by the at least one processor, cause the system to:
generate, using a decision support model and in response to receiving a first request from a client device for a first account within a digital system, an identity verification based on identifying information of the client device;
create the first account within the digital system for the client device based on the identity verification;
generate, in response to receiving a second request from the client device for a second account within the digital system, an indicator that the identifying information of the client device has remain unchanged for a threshold period of time; and
create the second account within the digital system for the client device using the identity verification generated in response to the first request based on the indicator generated in response to the second request.

10. The system of claim 9, further comprising instructions that, when executed by the at least one processor, cause the system to:
create the first account based on the identity verification generated in response to the first request by creating the first account based on a know your customer verification generated in response to the first request; and
create the second account using the identity verification generated in response to the first request based on the indicator generated in response to the second request by creating the second account based on the know your customer verification generated in response to the first request without generating an additional know your customer verification in response to the second request.

11. The system of claim 9, further comprising instructions that, when executed by the at least one processor, cause the system to:
receive, via one or more identity verification systems, one or more risk indicators for the client device based on the identifying information of the client device; and
generate the identity verification using the decision support model based on the identifying information of the client device by generating the identity verification using the decision support model based on the one or more risk indicators.

12. The system of claim 9, further comprising instructions that, when executed by the at least one processor, cause the system to generate the indicator that the identifying information of the client device has remain unchanged for the threshold period of time by generating the indicator that the identifying information of the client device has remain unchanged for at least two years.

13. The system of claim 9, further comprising instructions that, when executed by the at least one processor, cause the system to:
create a third account within the digital system for a second client device based on a second identity verification generated from identifying information of the second client device;
receive, from the second client device, an additional request to create a fourth account within the digital system; and
generate, in response to the additional request to create the fourth account, a request for additional identifying information of the second client device based on determining that the identifying information of the second client device has changed within the threshold period of time.

14. The system of claim 13, further comprising instructions that, when executed by the at least one processor, cause the system to:
generate the second identity verification from the identifying information of the second client device by generating, using the decision support model, the second identity verification from at least one of a first name, a last name, a date of birth, an email address, or a phone number associated with the second client device; and
generate the request for the additional identifying information of the second client device by generating the request for at least one of a digital photograph of a user associated with the identifying information of the second client device or a government-issued identification card associated with the second client device.

15. The system of claim 13, further comprising instructions that, when executed by the at least one processor, cause the system to:
receive the additional identifying information of the second client device;
generate, using the decision support model, a third identity verification based on the additional identifying information of the second client device; and
create the fourth account within the digital system for the second client device based on the second identity verification.

16. A non-transitory computer-readable medium storing instructions that, when executed by at least one processor, cause a computing device to:
generate, using a decision support model and in response to receiving a first request from a client device for a first account within a digital system, an identity verification based on identifying information of the client device;
create the first account within the digital system for the client device based on the identity verification;
generate, in response to receiving a second request from the client device for a second account within the digital system, an indicator that the identifying information of the client device has remain unchanged for a threshold period of time; and
create the second account within the digital system for the client device using the identity verification generated in response to the first request based on the indicator generated in response to the second request.

17. The non-transitory computer-readable medium of claim 16, further comprising instructions that, when executed by the at least one processor, cause the computing device to:
create a third account within the digital system for a second client device based on a second identity verification generated from identifying information of the second client device, the third account being associated with a third-party services system;
receive, from the second client device, an additional request to create a fourth account within the digital system, the fourth account being associated with an additional third-party services system; and
generate, in response to the additional request to create the fourth account, a request for additional identifying information of the second client device based on determining that the third-party services system and the additional third-party services system differ.

18. The non-transitory computer-readable medium of claim 16, further comprising instructions that, when executed by the at least one processor, cause the computing device to:
create the first account based on the identity verification generated in response to the first request by creating the first account based on a know your customer verification generated in response to the first request; and
create the second account using the identity verification generated in response to the first request based on the indicator generated in response to the second request by creating the second account based on the know your customer verification generated in response to the first request without generating an additional know your customer verification in response to the second request.

19. The non-transitory computer-readable medium of claim 16, further comprising instructions that, when executed by the at least one processor, cause the computing device to:
receive, via one or more identity verification systems, one or more risk indicators for the client device based on the identifying information of the client device; and
generate the identity verification using the decision support model based on the identifying information of the client device by generating the identity verification using the decision support model based on the one or more risk indicators.

20. The non-transitory computer-readable medium of claim 16, further comprising instructions that, when executed by the at least one processor, cause the computing device to generate the indicator that the identifying information of the client device has remain unchanged for the threshold period of time by generating the indicator that the identifying information of the client device has remain unchanged for at least two years.
